(19) United States
(12) Patent Application Publication
(10) Pub. No.: US 2022/0153324 A1
(43) Pub. Date: May 19, 2022

(54) WIRELESS ONBOARD RAILROAD BEARING CONDITION MONITORING SYSTEM

(71) Applicants: The Board of Regents of The University of Texas System, Austin, TX (US); Hum Industrial Technology, St. Louis, MO (US)

(72) Inventors: Constantine Tarawneh, Edinburg, TX (US); Heinrich Foltz, Edinburg, TX (US); Joseph Montalvo, Pharr, TX (US); Jonas Cuanang, Mission, TX (US); Brent Wilson, Edwardsville, IL (US); Byron Porter, Kirkwood, MO (US)

(21) Appl. No.: 17/097,831

(22) Filed: Nov. 13, 2020

(51) Int. Cl. B61K 9/04; B61F 15/12; B61L 15/00; G01M 17/10; G01P 15/00; G01K 7/02

(52) U.S. Cl. CPC B61K 9/04; B61F 15/12; B61L 15/0018; B61L 27/0094; G01P 15/00; G01K 7/02; G01M 17/10

(57) ABSTRACT

Described herein is a system and method that can accurately determine the presence of defects in the wheelset of a railcar during active use of the railcar.

### BACKGROUND OF THE INVENTION

### 1. Field of the Invention

The invention generally relates to a monitoring system used to detect defective components in a railcar wheelset during use of the railcar.

### 2. Description of the Relevant Art

The cargo load of a freight railcar is supported by the railcar's suspension components, namely: springs, dampers, axles, wheels, and tapered-roller bearings. Of these components, the bearings are the most susceptible to failure due to the heavy cargo loads at high speeds.

The tapered-roller bearing typically used in freight railcars has three different fundamental components, namely: rollers, inner rings (cones), and outer ring (cup). These components, shown in FIG. 1, allow for near-frictionless operation under heavy loads and high speeds. However, when one of these components develops a defect, the effectiveness of the near-frictionless rotation is compromised, which may lead to increased frictional heating depending on the size and location of the defect.

Pits, cracks, and spalls are usually the result of subsurface inclusions or defects close to the surface of the raceway (i.e., within 400 μm below the raceway surface). Types of subsurface inclusions include vacancies (small void of material) and contaminants and are the result of the supplier's manufacturing process. Subsurface inclusions close to the surface of the raceway turn into localized defects through rolling contact fatigue (RCF). Under constant RCF, micro-cracks appear around the subsurface inclusions and propagate to the raceway surface, causing metal to flake off and creating spalls on the raceway. The metal flakes get entrapped in the grease and begin creating new dents and pits on the raceway surfaces.

Bearings have a nominal service life of a minimum three million rail kilometers (two million rail miles) and are expected to fail due to fatigue. Precautions such as bearing condition monitoring systems are put into place to prevent catastrophic bearing failure.

The railroad industry currently utilizes two different types of wayside detections systems to monitor the health of the freight car bearings in service: The Trackside Acoustic Detection System (TADS™) and the wayside Hot-Box Detector (HBD).

TADS™ utilizes wayside microphones to detect high-risk defects in bearings and alert the conductor as the train passes by the system. A “growler” is an example of a high-risk defect in which spalls occupy more than 90% of the bearing component's rolling surface. The system is proficient in determining end-of-life bearings. However, there are less than 30 systems in service throughout the United States and Canada, and TADS™ is not capable of identifying defective bearings with small defects. These facts suggest that many bearings may spend their entire service life without passing through a TADS™ station, and many other bearings with small defects will go undetected as they pass through TADS™.

Hot-box detectors (HBDs) are the most utilized bearing condition monitoring systems in operation in North America with over 6,000 in use in the United States and Canada. HBDs are usually placed 40 km (25 mi) apart, with some positioned 64 km (40 mi) apart on rail lines with less traffic. HBDs use non-contact infrared sensors to measure the temperature radiated from the bearings, wheels, axles, and brakes as they roll over the detector. The HBD will alert the train operator of any bearings running at temperatures greater than 94.4° C. (170° F.) above ambient conditions or any bearings with an operating temperature greater than 52.8° C. (95° F.) as compared to their mate bearing that shares the same axle. However, bearings operating at temperatures above the average temperature of all bearings on the same side of the train, as detected by multiple HBDs, are said to be “warm trending”. Warm-trended bearings are flagged without triggering an HBD alarm and are subsequently removed from service for later disassembly and inspection.

Several laboratory and field studies have concluded that the accuracy and reliability of the HBD temperature readings are inconsistent. The measured temperatures can be significantly different from the actual operating temperature of the bearing. The latter can be attributed to several factors such as the class of the railroad bearing and its position on the axle relative to the position of the wayside detector, and environmental conditions that can affect the IR sensor measurements among other possible factors. Inconsistent HBD readings caused 106 severely defective bearings not to be detected by these condition-monitoring systems in the United States and Canada from 2010 to 2016; some of which resulted in costly catastrophic derailments. Attempts by some railroads to remedy the situation by using statistical analysis, run on HBD-acquired data, to set out bearings that run hotter than the average temperature of bearings along one side of the train have resulted in a significant increase in the number of non-verified bearings removed from service. In fact, about 40% of the bearings removed from service in the period from 2001 to 2007 were found to have no discernible defects. The removal of non-verified bearings has resulted in many costly train stoppages and delays.

From these studies, it has been shown that temperature readings alone are not sufficient for proper characterization of the health of a bearing in service. In some cases, bearings with large defects can run at normal operating temperatures for tens of thousands of miles before any abnormality in the operating temperature can be observed. In certain instances, a bearing's rolling raceway may deteriorate rapidly and cause severe roller misalignment. The misaligned rollers generate excessive frictional heating, which can weaken an axle within 60 to 135 seconds and may lead to a catastrophic derailment depending on the traveling speed of the train and the load it is carrying. The speed at which an axle can be weakened implies that catastrophic failure can occur between two consecutive HBDs, which highlights the need for better systems for the early and accurate detection of bearing defects.

The use of an onboard monitoring system has the potential to alleviate many of the problems associated with wayside detectors. Onboard monitoring systems are not constrained by any geographical restrictions and may provide real-time monitoring of the bearing conditions. An ideal onboard bearing condition monitoring system is one that is cost-effective, easily installed/replaced, and can accurately detect and monitor bearing defect growth, amongst other performance metrics. Ideally, such a system would alert the locomotive engineer of any possible defects and provide an estimation of the remaining life a defective bearing has. This estimation would allow for the railcar to remain in service for longer periods from initial defect detection when compared to other defect detection systems.

### SUMMARY OF THE INVENTION

In an embodiment, wheelset monitoring device coupled to a bearing adapter, the wheelset monitoring device includes: a body having a shape and size configured to allow the body to be mounted against a portion of the bearing adapter; one or more vibration sensors positioned with the body; a processor coupled to the one or more vibration sensors; and a transmitter coupled to the processor. During use, vibration information, monitored by the vibration sensors is collected by the processor and at least some of the vibration information is transmitted by the transmitter to a remote receiving device. In an embodiment, the body comprises one or more openings extending through a portion of the body. Fasteners may be passed through the openings to connect the body to the portion of the bearing adapter.

In an embodiment, the shape and size of the body is such that, when the entire body is in contact with the bearing adapter, a portion of the body is disposed over the center of the bearing adapter. At least one vibration sensor is positioned in the portion of the body disposed over the center of the bearing adapter. In an embodiment, a marking may be made on the body indicating the location of a vibration sensor that is intended to be positioned over a center of the bearing adapter.

In an embodiment, the body comprises a first compartment and a second compartment, the first compartment comprising one or more of the vibration sensors, and the second compartment comprising the processor, the transmitter and the power source. The first compartment and second compartment may be angled with respect to each other. In an embodiment, the angle of the first compartment with respect to the second compartment is greater than 90 degrees.

In an embodiment, one or more temperature sensors positioned within the body. One or more openings may be formed in the body at or near a location of one of more of the temperature sensors. The one or more openings are formed in a contact surface of the body.

In an embodiment, a bearing adapter of a railcar includes: a body having a substantially planar top surface, an arced bottom surface, and sidewalls connecting the top surface to the bottom surface, wherein the top surface receives a portion of a railcar side frame during use, and wherein the arced bottom surface rests on a portion of a bearing assembly during use; one or more vibration sensors coupled to the body; and a control unit coupled to the body and the one or more vibration sensors, wherein the control unit comprises a processor, a transmitter coupled to the processor, and a power source coupled to the processor and the transmitter. During use, the vibration information, monitored by the vibration sensors is collected by the control unit and at least some of the vibration information is transmitted by the transmitter to a gateway device.

In an embodiment, at least one vibration sensor is positioned above a center of the bearing assembly during use. In an embodiment, one or more temperature sensors are coupled to the body.

In an embodiment, a method installing a wheelset monitoring device on a bearing adapter includes: obtaining a wheelset monitoring device, as described herein; and attaching the body of the wheelset monitoring device against a sidewall of the bearing adapter. When attaching the body to the bearing adapter, the body is positioned such that at least one vibration sensor disposed within the body is oriented over a center of the bearing adapter.

The wheelset monitoring device may include a marking on the body indicating the location of a vibration sensor that is intended to be positioned over a center of the bearing adapter. When attaching the body against a sidewall of the bearing adapter, the marking is positioned at the center of the bearing adapter.

In an embodiment, a method installing a vibration sensor on a bearing adapter includes:

obtaining one or more vibration sensors; and attaching the one or more vibrations sensor against a sidewall of the bearing adapter such that at least one vibration sensor is oriented over a center of the bearing adapter. One or more temperature sensors may also be attached to the bearing adapter.

In an embodiment, a method of determining the presence of a defect in a railcar wheelset includes: continuously monitoring operating conditions of the wheelset at a first computational frequency during use of the railcar; continuously comparing the monitored operating conditions to a pre-determined operating condition threshold value, wherein the pre-determined operating condition threshold value is determined from an analysis of monitored operating conditions of one or more wheelsets having undamaged components. If the monitored operating conditions exceed the pre-determined operating condition threshold value, the computational frequency for monitoring the operating conditions of the wheelset is increased, for a predetermined amount of time, to a second computational frequency. The method further includes analyzing the monitored operating conditions collected at the second computational frequency to determine if a defect is present in a railcar wheel set.

Monitoring the operating conditions of the wheelset comprises monitoring the operational conditions of at least one bearing assembly of the wheelset. Operating conditions of the bearing assembly include, but are not limited to, the vibration signature of the bearing assembly and/or the temperature of the bearing assembly. Monitoring the operating conditions of the wheelset may also include monitoring the vibration signature of at least one wheel of the wheelset.

In an embodiment, a method of determining the presence of a defect in a railcar wheelset further includes determining the speed of the railcar and continuously comparing the monitored operating conditions to a pre-determined operating condition threshold value. The pre-determined operating condition threshold value is determined from an analysis of monitored operating conditions at the determined speed of one or more wheelsets having undamaged components.

In an embodiment, an alert signal is created if a defect is determined to be present in the railcar wheelset. If a defect is present, the method further comprises categorizing the defect as an imminent defect if immediate action is required. The alert signal provided may be indicative of the need for immediate action.

In an embodiment, a method of determining the presence of a defect in a railcar wheelset includes: monitoring a vibration signature of the wheelset during use of the railcar; and comparing the monitored vibration signature to one or more vibration signatures of a wheelset having damaged components to determine the type of defect present in the railcar wheelset.

In an embodiment, the method further includes determining the speed of the railcar and comparing the monitored vibration signature to one or more vibration signatures of a wheelset having damaged components operating at substantially the same speed.

In an embodiment, the method further comprises determining which component of the wheelset is damaged, based on the comparison of the monitored vibration signature to one or more vibration signatures of a wheelset having damaged components. The method may also include determining an estimated time remaining before the damaged component fails, based on the comparison of the monitored vibration signature to one or more vibration signatures of a wheelset having damaged components.

In an embodiment, an alert signal is created indicating the component of the railcar wheelset in which a defect is determined to be present. If a defect is present, the method further comprises categorizing the defect as an imminent defect if immediate action is required. The alert signal provided may be indicative of the need for immediate action.

In an embodiment, a method of creating a library of vibration signatures of wheelsets comprising damaged components comprises: monitoring vibration signatures from wheelsets having a one or more damaged components, wherein the identity of the damaged component is known; and applying machine learning analysis to the collected vibration signatures to determine a vibration signature indicative of the damaged component.

In an embodiment, monitoring the vibration signature of the wheelset having a damaged component comprises monitoring the vibration signature of at least one bearing assembly of the wheelset. The method may also monitor the temperature of at least one bearing assembly of the wheelset.

The wheelset having a known damaged component may have a damaged bearing assembly. A damaged bearing assembly may have a damaged cup, a damaged cone, and a damaged roller.

In an embodiment, the vibration signature of the wheel set having a damaged component includes a vibration signature of at least one damaged wheel of the wheelset.

In an embodiment, the method further includes determining the speed of the wheelset. The machine learning analysis is applied to one or more wheelsets having a damaged component operating at the same speed.

The method may also include associating an estimated time remaining before the damaged component fails with the vibration signature indicative of the damaged component.

In an embodiment, a method of determining the presence of a defect in a railroad track includes: monitoring a vibration signature of the wheelset during use of the railcar on the railroad track; and comparing the monitored vibration signature to one or more vibration signatures of a wheelset passing over known damaged track components to determine if a defect is present in the railroad track.

### BRIEF DESCRIPTION OF THE DRAWINGS

Advantages of the present invention will become apparent to those skilled in the art with the benefit of the following detailed description of embodiments and upon reference to the accompanying drawings in which:

FIG. 1 depicts a cut-away view of a bearing assembly;

FIG. 2 depicts a side-view of a railcar wheelset;

FIG. 3 depicts a projection view of a bearing adapter;

FIG. 4 depicts a schematic diagram of a defect monitoring system;

FIG. 5 depicts a side view of a bearing adapter mounted to a bearing assembly, having vibration sensor and temperature sensors;

FIG. 6A depicts a front view of a wheelset monitoring device;

FIG. 6B depicts a back view of a wheelset monitoring device;

FIG. 7A depicts a top view of a wheelset monitoring device attached to a bearing adapter; and

FIG. 7B depicts a side view of a wheelset monitoring device attached to a bearing adapter.

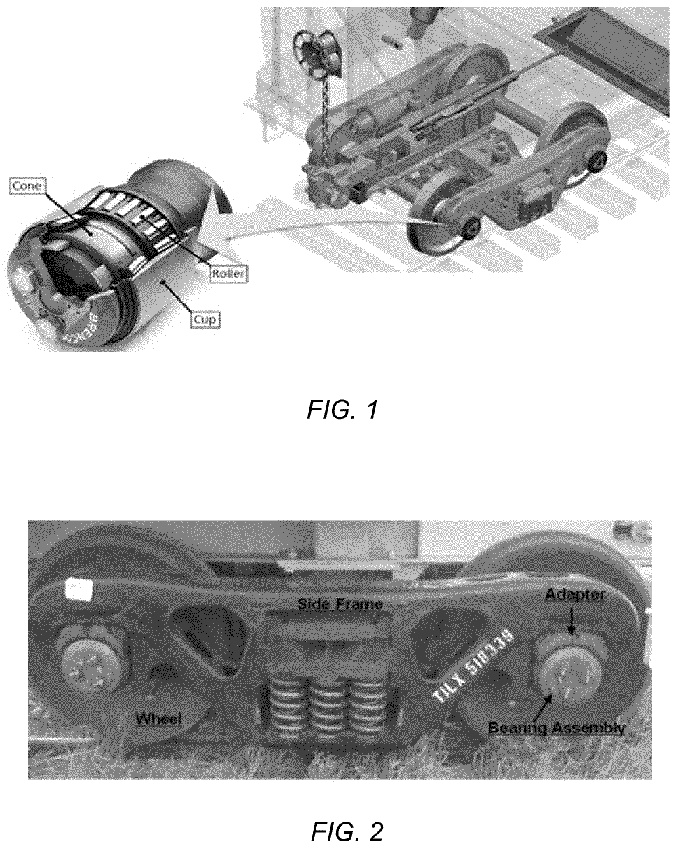

While the invention may be susceptible to various modifications and alternative forms, specific embodiments thereof are shown by way of example in the drawings and will herein be described in detail. The drawings may not be to scale. It should be understood, however, that the drawings and detailed description thereto are not intended to limit the invention to the particular form disclosed, but to the contrary, the intention is to cover all modifications, equivalents, and alternatives falling within the spirit and scope of the present invention as defined by the appended claims.

### DETAILED DESCRIPTION OF THE PREFERRED EMBODIMENTS

It is to be understood the present invention is not limited to particular devices or methods, which may, of course, vary. It is also to be understood that the terminology used herein is for the purpose of describing particular embodiments only, and is not intended to be limiting. As used in this specification and the appended claims, the singular forms “a”, “an”, and “the” include singular and plural referents unless the content clearly dictates otherwise. Furthermore, the word “may” is used throughout this application in a permissive sense (i.e., having the potential to, being able to), not in a mandatory sense (i.e., must). The term “include,” and derivations thereof, mean “including, but not limited to.” The term “coupled” means directly or indirectly connected.

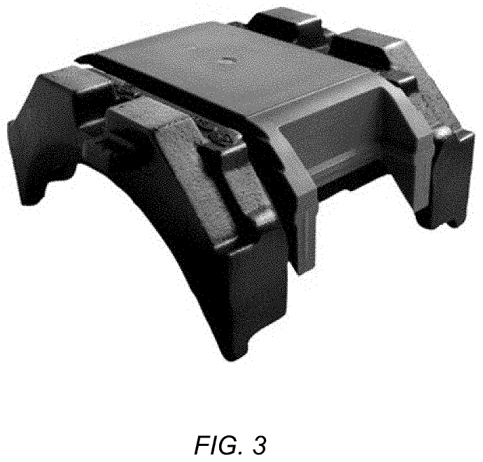

A side view of a railcar truck assembly 200 is depicted in FIG. 2. The railcar truck assembly includes a pair of side frames 210 on opposing sides of the assembly (only one side is depicted in FIG. 2). A pair of downward openings 220 are formed in the side frames. The openings receive the bearing assemblies 230 from the wheelset. A wheelset includes an axle, two wheels 240 attached to the axle and two bearing assemblies 230, typically attached to the ends of the axle. The axel rotates within the bearing assembly during use. A bearing adapter 250 is positioned between side frame 210 and the bearing assembly 230. Bearing adapter 250 provides a connection between side frame 210 of the railcar and bearing assembly 230. An exemplary bearing adapter is depicted in FIG. 3. Bearing adapter 250 has two contact surfaces designed to contact different components of the railcar. Top surface 252 is generally planar and rests against a complementary planar surface of side frame 210. Bottom surface 254 is curved or arced, and rests against the cylindrical outer surface of bearing assembly 230. The direct contact of the bearing adapter with the bearing assembly makes it an ideal location for monitoring the condition of the wheelset, generally, and the bearing assemblies, specifically.

Embodiments described herein are directed to the implementation of an onboard condition monitoring system that can accurately and reliably detect the onset of bearing failure. The onboard condition monitoring system currently utilizes temperature and vibration signatures to monitor the true condition of a bearing. The use of vibration signatures of a bearing is a more effective method to assess the bearing condition than monitoring temperature alone. The described onboard condition monitoring system is capable of identifying a defective bearing using the vibration signature, whereas, the temperature profile of that same bearing will indicate a healthy bearing that is operating normally.

In one embodiment, a system for monitoring the components of a wheelset includes: (1) one or more sensors coupled to a portion of a wheelset, and (2) a gateway device attached to the railcar that receives incoming data from the sensors. A typical railcar includes four wheelsets, each wheelset having two opposing bearing assemblies. In an embodiment, sensors are positioned on and/or proximate to each of the eight bearing assemblies. Positioning sensors on each of the bearing assemblies allows each bearing assembly to be individually monitored. These sensors and the gateway device work in combination to send and receive actionable data necessary to report the continuous running condition of the railcar bearings and wheels, as well as track aberrations. This data can be used to determine if a defect is present in the wheelset and/or track. Furthermore, comparative analysis of the collected data can be used to predict the expected lifetime of the defective component.

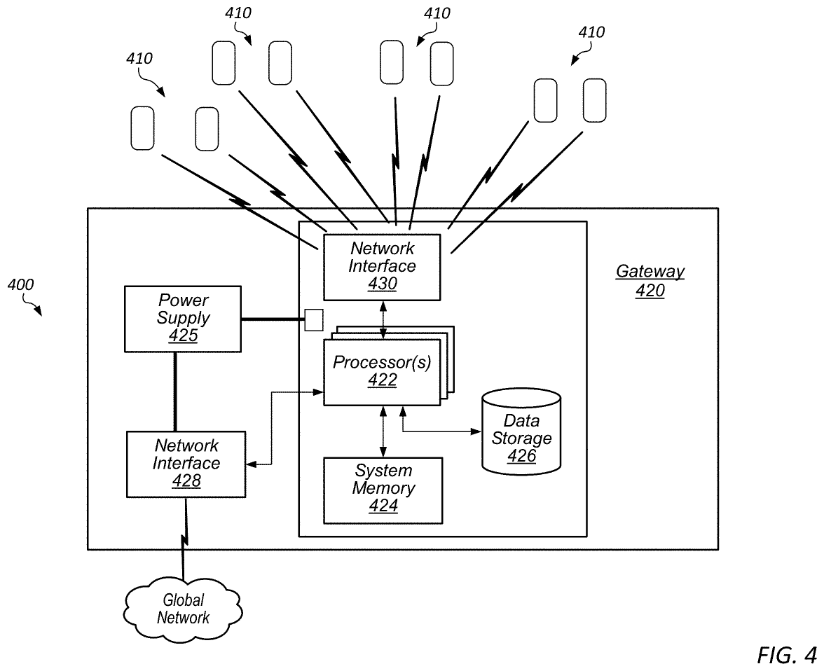

FIG. 4 depicts a schematic diagram of a system 400 for monitoring the components of a wheelset. System 400 includes a plurality of wheelset monitoring devices 410 (e.g., a sensor or a group of sensors) and a gateway device 420. Wheelset monitoring devices 410 communicate with gateway device 420 through wireless connections. One or more wheelset monitoring devices 410 may include a transmitter (or transceiver) to enable wireless communication with gateway device 420. Gateway device 420 may include a local network interface device 430 which can receive information from the wheelset monitoring devices. Local network interface device includes a receiver (or transceiver) which enables wireless communication with the wheelset monitoring devices. In some embodiments, one or more wheelset monitoring devices 410 may be connected to gateway device 420 (e.g., via local network interface device 430) through a wired connection.

Gateway device 420 includes one or more processors 422, system memory 424, and data storage device 426. Program instructions may be stored on system memory 424. Processors 422 may access program instructions on system memory 424. Processors 422 may access and store data on data storage device 426. Gateway device may also include a power supply 425 and a global network interface device 428. In some embodiments, the global network interface device 428 is provided with a cellular network connection using current cellular networking standards (such as 4G LTE or 5G). Gateway device 420 may also include a Global Positioning System (GPS). A GPS may be built into the gateway device to provide the current location of the railcar. Placing a GPS in the gateway device will reduce the power and data usage of the existing onboard GPS. Having a GPS in each railcar also allows the railcar owner to monitor the location of the railcar, and the associated load, at all times without need for inquires to the train operators.

In an embodiment, the gateway device system creates an internal network throughout the railcar that links most, if not all, sensors to the gateway device. The internal network includes one or more wheelset monitoring devices dispersed in one or more railcars. The wheelset monitoring devices may include a transmitter/receiver pair, or a transceiver, to allow bi-directional communications within the internal network. In an embodiment, Bluetooth 5.1 protocol is used for data collection from the wheelset monitoring devices.

In an embodiment, one or more of the wheelset monitoring devices include a processor to allow edge computing of the incoming sensor data. As used herein the phrase “edge computing” refers to the practice of processing data in the device, or a separate processor, at the location that the data is being generated. “Edge computing” minimizes the use of a centralized data-processing center, and thus minimizes the amount of data transferred over the network. In addition, the data node processor may also utilize fuzzy logic to allow the processor to “learn” the typical operating and usage patterns associated with the equipment and events (e.g., specific common vibration signatures) for the specific train railcar.

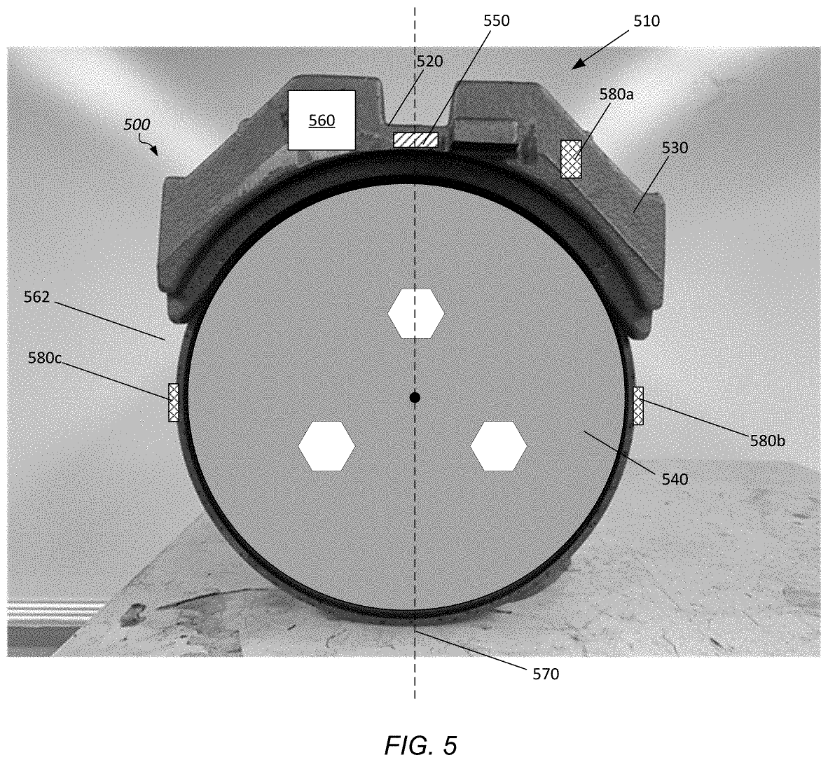

In one embodiment, a bearing adapter may be modified by attaching one or more wheelset monitoring devices (e.g., vibration and temperature sensors) onto the outer surface of the bearing adapter. FIG. 5 depicts a side view of a bearing adapter 500 having wheelset monitoring sensors attached to the bearing adapter. Bearing adapter 500 includes a body 510 having a substantially planar top surface 510, an arced bottom surface 520, and sidewalls 530 connecting the top surface to the bottom surface. Top surface 510 receives a portion of a railcar side frame (See FIG. 2) during use. Arced bottom surface 520 rests on a portion of a bearing assembly 540. Wheelset monitoring sensors includes one or more vibration sensors 550 coupled to body 510. Bearing adapter also includes a control unit 560 coupled to body 510 and the one or more vibration sensors. Control unit 560 includes a processor and a transmitter. Control unit may also include a power source. The power source may be used to provide power to the control unit 560. In one embodiment vibration sensor(s) are coupled to control unit 560 through a wireless connection. Many modern sensors (e.g., vibration sensors and temperature sensors) include a power source and a communication device (transmitter/receiver) incorporated into a unitary package. The sensors, therefore, are self-powered and can provide monitored data through a wireless connection. While depicted as a wireless system, sensor units may be coupled to control unit 560 through a wired connection.

The wheelset monitoring sensors and the control unit may be attached to a bearing adapter that is installed on a railcar. Wheelset monitoring sensors and the control unit may be connected to the bearing adapter body using fasteners (e.g., screws), adhesives, or magnetic connectors. By fastening the wheelset monitoring sensors and the control unit to the outer, exposed surfaces of the bearing adapter (as shown in FIG. 5), any bearing adapter on an in-service railcar may be retrofitted with a wheelset monitoring system. Retrofitting a bearing adapter, in such a manner, avoids the need to remove the bearing adapter to incorporate the sensors.

The wheelset monitoring sensors are used to monitor, at least, vibration information. Typical vibration sensors rely on accelerometry for the detection of vibrations. A variety of different vibrations sensors may be used. Most common vibration sensors are sensors that include an accelerometer. When the train is in motion, the railcars are pulled along the railroad track. Suring this movement, the axle holding the wheels rotates within the bearing assembly, allowing the wheels to rotate freely in response to the motion of the locomotive. The vibration information, monitored by the vibration sensors, is collected by the control unit. The control unit passes the collected vibration information (before or after filtering the information) to the gateway device. The gateway device may process the data to determine a vibration signature associated with the current vibrations detected by the vibration sensors. This data may be further analyzed to determine if a defective component is present in the wheelset as it is monitored.

To obtain accurate vibration information, it has been found that at least one vibration sensor should be positioned at the center of the bearing adapter. Referring to FIG. 5, a centerline 570 is shown that runs through the center of the bearing adapter. Because of the way the bottom surface of the bearing adapter is shaped, the center of the bearing adapter also corresponds with the center of the bearing assembly and the center of the axle. It has been found that the most accurate vibration information is obtained when a vibration sensor is positioned at the center of the bearing adapter, right above the bearing assembly.

In some embodiments, one or more temperature sensors 580 may be coupled to the bearing adapter (580a) or to the bearing assembly (580b,c). As discussed above, when a problem occurs in a bearing assembly, many times this condition can lead to overheating of the bearing assembly. The bearing assembly will, therefore, become hotter than the typical temperature seen during use of the railcar. To monitor the temperature of the bearing assembly, one or more temperature sensors may be placed on the outer surface of the bearing assembly. Alternatively, one or more temperature sensors may be placed on the bearing adapter. Since the bearing adapter is in contact with the bearing assembly, the heat from the bearing assembly is partially transferred into the metal body of the bearing assembly. During an analysis of the condition of the bearing assembly, while the railcar is in use, an increase in temperature of the bearing assembly may be indicative of an abnormal condition at or proximate to the bearing assembly.

In an alternate embodiment, sensors for monitoring the condition of a railcar bearing assembly may be incorporated into a sensor enclosure which attaches to the outer surface of a railcar bearing adapter. The use of an externally mounted sensor enclosure allows the easy incorporation of sensors onto railcar bearing adapters without the need for removal and/or disassembly of the railcar bearing adapters.

In one embodiment, a system for monitoring the condition of a railroad bearing adapter includes a wireless sensor enclosure that is configured to be connected to the outer surface of the railcar bearing assembly. The wireless sensor enclosure includes one or more wireless sensors that are suitable for monitoring the condition of the bearing adapter.

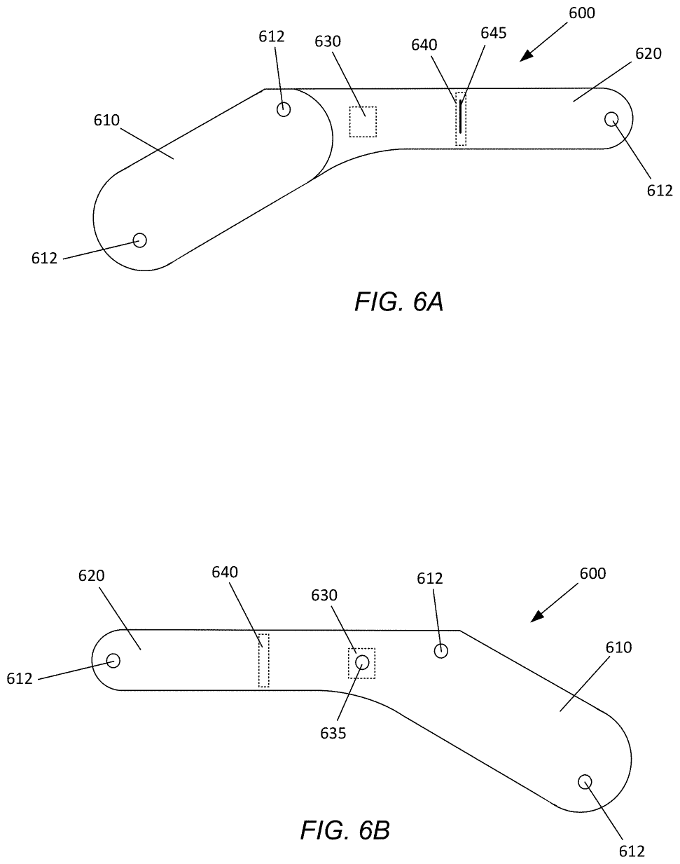

An embodiment of a wheelset monitoring device 600 is depicted in FIG. 6. FIG. 6A depicts a front view of the wheelset monitoring device and FIG. 6B depicts a back view of the wheelset monitoring device. During use, the wheelset monitoring device is attached to a railcar bearing adapter such that the back side of the wheelset monitoring device (i.e., the contact surface) is in contact with a side of the railcar bearing adapter.

The wheelset monitoring device, in some embodiments, includes a body, composed of a first compartment 610 and a second compartment 620. In one embodiment, first compartment 620 includes one or more vibration sensors (e.g., an accelerometer) 640 and one or more temperature sensors (e.g., a thermocouple) 630. Second compartment 610 encloses a processor, processor memory, data transmission components and a power supply. The first compartment and the second compartment, together, form a body of the wheelset monitoring device. In an embodiment, the shape and size of the body is such that the entire body is in contact with the bearing adapter when attached to the bearing adapter. The first compartment and/or the second compartment may also include a speed sensor for monitoring the speed of the railcar and a location device for determining the location of the railcar. In some embodiments, a GPS, located in the gateway device, may be used for determining both speed and location of the railcar. In one embodiment, the first compartment and the second compartment are angled with respect to each other. For example, the angle of the first component with respect to the second compartment may be greater than 90 degrees. Angling of the compartments allows the device to be placed on a bearing adapter, following the contours of the body of the bearing adapter.

The body of the wheelset monitoring device, includes one or more openings 612 that extend through a portion of body of the wheelset monitoring device. The one or more openings may allow one or more fasteners to be passed through wheelset monitoring device 600 to fasten the device to the railcar bearing adapter. In some embodiments, a screw (e.g., a self-tapping screw) may be used to attach wheelset monitoring device 600 to a railcar bearing adapter.

In one embodiment, the wheelset monitoring device includes one or more temperature sensors. Temperature sensors 630 may be located in either the first compartment and/or the second compartment. Opening 635 may be positioned over thermocouple 630 on back side (contact side) of wheelset monitoring device 600 to allow heat to be more easily transferred from the railcar bearing adapter to the temperature sensor.

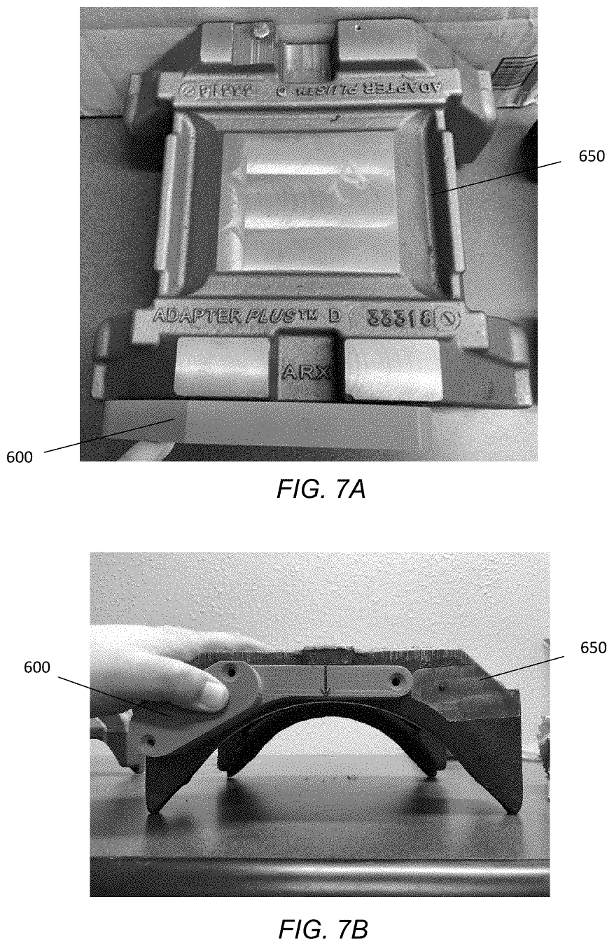

At each bearing adapter position on a railcar, a wheelset monitoring device 600 may be placed. FIG. 7A depicts a top view of a railcar bearing adapter having wheelset monitoring device 600 attached to the side of bearing adapter 650. FIG. 7B depicts a side view of a railcar bearing adapter having wheelset monitoring device 600 attached to the side of the bearing adapter.

The wheelset monitoring device may be positioned at the center position of the roller bearing (as shown in FIG. 7B), which places the device at the ideal orientation and position for monitoring bearing and wheel performance and condition. Additionally, track vibration is also measurable at this location for the assessment of excessive track perturbation and/or condition, along with derailments at low or high speeds.

In one embodiment, wheelset monitoring device 600, has a shape and size such that, when the entire body is in contact with the bearing adapter, a portion of the body is disposed over the center of a bearing adapter. At least one vibration sensor is positioned in the portion of the body disposed over the center of the center of the bearing adapter. In one embodiment, the body of wheelset monitoring device includes a marking 645 on the body indicating the location of a vibration sensor. The marking may, for example, indicates the location of a vibration sensor that is intended to be placed at the center of the bearing adapter.

In an embodiment, a wheelset monitoring device is installed onto a bearing adapter that is part of an active railcar. The wheelset monitoring device may be installed without having to remove or disassemble the bearing adapter. To ensure proper placement of the wheelset monitoring device, an installer may use a marking on the wheelset monitoring device. After obtaining a wheelset monitoring device, the installer will use the marking to ensure that a vibration sensor disposed in the proper position. For example, the marking may indicate the position of a vibration sensor that should be positioned at the center (See FIG. 5) of the bearing adapter.

Bearing and wheel failures can occur in-service due to a multitude of aberrant mechanical or physical deviations from their normal operating condition. On one embodiment, the wheelset monitoring device continuously monitors the rolling condition of the wheelset assembly and track against pre-determined threshold values established by the machine learning (ML) algorithm. If certain thresholds are exceeded, the CPU begins to collect a fixed time series of data, and subsequently performs basic computations necessary to assess the level of degradation. The computed values are sent wirelessly, through the transmitter, to the gateway device. The gateway device receives the data, checks the current speed, and then classifies the inputs using the ML model. The resulting data and inputs may also be transmitted to a data Cloud for storage and evaluation.

The early stage fault detections, detected using the sensor enclosure, provide the end-user with actionable data and information that allow for predictive maintenance decisions to be made by the railcar owner. Early warning levels provide time based prognoses ranging from 3-12 months of remaining component life (depending on severity/service/type), which are graded by stating an empirically estimated ‘remaining life’ of the component such that the end-user can take appropriate maintenance actions without disrupting train operation, rather than the current reactive maintenance system consisting of wayside defect detectors, which requires trains to stop for ‘in-time’ maintenance to be performed.

Additionally, due to any number of mechanical defects in the wheelset or track, imminent failure modes can be detected that require immediate action, i.e. alarm conditions. In the event of an imminent failure mode, triggered alarms significantly in excess of the normative operating condition of the component are regarded as actionable, and require attention from the railcar carrier. These events are structured to avoid train stoppages, and initiate with a reduction in speed until such time that the alarm level threshold is not exceeded. Operation at reduced speeds can be continued until an appropriate stopping point is reached that will allow on-track maintenance of the component to be performed. In the event that an alarm threshold is continuously exceeded, even at reduced speeds, then appropriate action must be taken to stop the train prior to catastrophic failure.

All customers can monitor and view the location and mechanical condition of the railcar through a web-based dashboard application or through integration with a customer's current data warehouse through the use of API's (Application Programming Interfaces). The location of any asset can also be tracked through a Google-based map integrated with a search function to find one or more specific railcars by ID number. And finally, sensor data provided by the Gateway system updates the web application on a continuous basis with component condition information about each connected railcar.

The devices can also be integrated and used on railcars without any additional hardware requirements.

Vibration monitoring often uses significant amounts of processing resources that consume a large amount of power. Because vibration data includes vibrations from various components (e.g., bearing assemblies, wheels, track) it is important that a sufficient amount of vibration data is collected. However, continuous collection of vibration information, sufficient to determine a vibration signature associated with the bearing assembly, could use significant amounts of power, as the processor may need to operate at a high frequency to process the data. This issue is particularly challenging for a wheelset monitoring device, which is a power constrained platform.

In one embodiment, the power consumption of a wheelset monitoring system may be optimized by altering the performance setting of the processor. In one implementation, dynamic frequency scaling (DFS) may be used to change the frequency of the processor to optimize the power consumption. During operation of a railcar, wheelset monitoring device may be used for continuous monitoring of the operating conditions of the wheelset at a first computational frequency. The “operating conditions” of the wheel set refers to, at least, the vibrations and temperatures encountered during use of the use of the railcar. During this initial monitoring of the vibrations, the operating condition data collected at the first computational frequency is continuously compared to a pre-determined operating condition threshold value. If the monitored operating conditions exceed the pre-determined operating condition threshold value, the computational frequency for monitoring the operating conditions of the wheelset is increased, for a predetermined amount of time, to a second computational frequency. Increasing the computational frequency allows the wheelset monitoring device to collect more information at a faster rate. The wheelset monitoring device (or the gateway processor) analyzes the monitored operating conditions collected at the second computational frequency to determine if a defect is present in a railcar wheelset.

The pre-determined operating condition threshold value is determined from an analysis of monitored operating conditions of one or more wheelsets having undamaged component. In one embodiment, the pre-determined operating condition threshold value was selected based on a statistical analysis of defect-free bearing assembly vibration signatures operating at the same or similar speeds. The ideal pre-determined operating condition threshold value should be set to minimize the amount of defective bearings below the threshold while also limiting the amount of defect-free bearings above the threshold.

In an embodiment, monitoring the operating conditions of the wheelset includes monitoring the operational conditions of at least one bearing assembly of the wheelset. The operating conditions of the bearing assembly includes the vibration signature of the bearing assembly and the temperature of the bearing assembly. In one embodiment, monitoring the operating conditions of the wheelset comprises monitoring the vibration signature of at least one wheel of the wheelset.

Vibration noise generated during operation of a railcar can vary significantly with the speed of the railcar. In an embodiment, the monitored operating conditions of the wheelset is compared to a pre-determined operating condition threshold value. The pre-determined operating condition threshold value is determined from an analysis of monitored operating conditions at the determined speed of one or more wheelsets having undamaged components.

In an embodiment, an alert signal is provided if a defect is present in the railcar wheelset.

If a defect is present, the method further comprises categorizing the defect as an imminent defect if immediate action is required. Under such circumstances, the alarm provided is indicative of the need for immediate action.

After collecting the operating conditions of a railcar wheelset, the data is analyzed to determine the presence of a defect. In one embodiment, a multi-level analysis algorithm is used to determine the presence of a defect in a railcar wheelset.

The first level analysis is intended to determine if a defect may be present in a railcar wheelset from a vibration analysis of the wheelset. In the first level analysis, vibrations are monitored from one or more wheelsets of the railcar during use. The vibration signals are compared to a pre-determined vibration threshold. If the vibration signals exceed the vibration threshold, the wheelset is flagged as having a defective part. The system then switches the flagged wheelset for a second level analysis. Since the first level analysis is used to determine the presence of a defect, without necessarily identifying the defect, the first level analysis is performed at a minimized computational frequency to reduce the power used by the wheelset monitoring device.

In a level 1 analysis, two speed-dependent thresholds may be used to identify the presence of a damaged component. The two speed-dependent thresholds were developed using a library of defect-free wheelset vibration signatures acquired through laboratory testing. The vibration values acquired during Level 1 analysis are compared against these thresholds. The “Preliminary Threshold” was selected based on a statistical analysis of several possible thresholds based on correlations of speed and the mean vibration values of defect-free wheelset vibration signatures. If the vibration value is below the “Preliminary Threshold,” then the wheelset is categorized defect-free, and the data collection continues at Level 1. Conversely, if the vibration value of a wheelset is greater than the “Preliminary Threshold,” then the wheelset is determined to be possibly defective, and the algorithm will proceed to a Level 2 analysis. The “Maximum Threshold” was developed so that all wheelsets with a vibration value above it are flagged as defective. The “Maximum Threshold” is based on a correlation between the maximum defect-free vibration values for each speed data set versus the speed.

If a wheelset is designated as having a probable defective component during the level 1 analysis, the analysis is switched to a second level analysis for the defective component. When switched to a level 2 analysis, the computational frequency is increased at the designated defective wheelset. Other wheelsets which did not exhibit vibration signatures above the vibration threshold continue to be monitored at the first analysis level.

The data from the level 2 analysis is used to generate a vibration signature of the wheelset(s) during use. As used herein a “vibration signature” of the bearing assembly is the characteristic pattern of vibration the bearing assembly generates while it is in operation. The frequency spectrum of the vibration signal of a bearing assembly is referred to as the signature. The vibration signature of the wheelset is compared to a library of vibration signatures generated from one or more railcar wheelsets having damaged components to determine if a defect is present. A match of the vibration signature of the monitored wheelset with one or more of the vibration signatures in the library will indicate that a defect may be present in the monitored wheelset and the identity of the defective component.

A library of vibration signatures of defective components of a wheelset may be generated by placing a component having a known defect in a wheelset of a railcar and collecting the vibration information at various speeds. A machine learning analysis may be performed on data obtained from different tests to isolate the specific vibrations that are indicative of the defect being studied.

In one embodiment, the damaged component is the bearing assembly. Different parts of the bearing assembly may be damaged. Typical damage to a bearing assembly occurs in the cup, in the cone, or in the roller. In one embodiment, a library of vibration signatures associated with defects in a bearing assembly is created by monitoring vibration signatures when a defect is present in the cup, the cone, the roller, or any combination of these components. Furthermore, the vibration signatures of defective bearing assemblies are generated at different speeds. The library will therefore include vibration signatures associated with the most common defects in bearing assemblies at a wide range of speeds.

Damage to the wheels or the railroad track may also be assessed in a similar manner. To determine is the damage component is a wheel, the vibration signatures of a bearing assembly may be filtered out of the vibration information collected, leaving only the vibration information associated with the motion of the wheels over the track. As was done with the bearing assembly, the vibration signature associated with the movement of the wheels over the track may be compared to a library of vibration signatures obtained from railcars having defective wheels, or moving over defective tracks.

The level 2 analysis is used to determine if a defect is present. This is typically done by comparison of the vibration signatures from the wheelset being monitored to the library of vibration signatures. A match between the vibration signature of the wheelset to one or more entries in the library can be used to determine the specific component that is defective. Since the vibration signatures change as the speed of the railcar changes, the speed of the railcar, along with the vibration signature, is used to determine if there is match between the vibration signature and the defective component. After completion of a level 2 analysis, the system may perform a level 3 analysis.

As noted above, a vibration signature library includes vibration signatures for specific defective components at specific speeds. An expected time until failure of the defective component may also be associated with each vibration signature in the vibration signature library. In a level 3 analysis, the expected time of failure may be determined since the extent of damage to the component is known when generating the vibration signature library. In an embodiment, a level 3 analysis may provide an estimate of the amount of damage that is present in the defective component and the expected time until failure of the defective component.

In an embodiment, an alert signal is provided if a defect is present in the railcar wheelset at the level 1 analysis. The alert signal generated from a level 1 analysis (a “level 1 alert”) may provide an indication that a defect is present, and the location of the defect. The level 1 alert may also provide an indication that a level 2 analysis has begun at the location of the defect. After a level 2 analysis is completed, a level 2 alert is provided. In the level 2 alert, the probable identity of the defective component is provided. If a level 3 analysis is performed, a level 3 alert may provide an indication of the amount of damage that is present in the defective component and the expected time until failure of the defective component. A level 3 alert may also categorize the defect as an imminent defect if immediate action is required. Under such circumstances, the level 3 alert provides an indication of the need for immediate action.

### Field Test Data

A railcar was instrumented, with vibration sensors (accelerometers) and temperature sensors (thermocouples) on the bearing adapter and the bearing assembly. This test was set up as a blind test in order to validate the developed vibration-based wheelset condition monitoring technology. Hence, four defective and four healthy bearings were strategically positioned throughout the railcar. Bearing L1 had a defective cone with a total spall area of 14.2 cm² (2.2 in²). Bearing R2 had a defective outer ring (cup) with a total spall area of 34.2 cm² (5.3 in²). The railcar operated at speeds of 48 km/h (30 mph), 80 km/h (50 mph), and 89 km/h (55 mph) with a full load (153 kN or 34.4 kip per bearing). The average ambient temperature during this test was 17.5° C. (63.5° F.).

The defective Bearings L1 and R2 were found to have vibration levels that are, on average, 50% higher than those for the healthy Bearings L2 and R1. When comparing these four bearings to the control bearing values, it is evident that Bearings L1 and R2 operating at 100% load with speeds of 89 km/h (55 mph) and lower exhibit vibration levels that are 33% higher than those of the control bearing operating at a speed of 137 km/h (85 mph) with an overload of 110%. In contrast, Bearings L2 and R1 have vibration levels that fall in-line with the control bearing. Examining the temperature histories of the four bearings, it can be observed that the defective Bearings L1 and R2 are running at higher operating temperatures than those of the healthy Bearings L2 and R1, but the operating temperatures of all four bearings are well below the average operating temperatures given by the control bearing correlation. Moreover, the operating temperatures of the two defective bearings are well below the HBD alarm threshold. Similar trends are shown by the back four bearings for this test day, and for the second day field tests performed under different loading conditions. This indicates that vibration testing is substantially more effective than temperature sensing for the determination and identification of defective components in a railcar wheelset.

The examples set forth herein are included to demonstrate preferred embodiments of the invention. It should be appreciated by those of skill in the art that the techniques disclosed in the examples which follow represent techniques discovered by the inventor to function well in the practice of the invention, and thus can be considered to constitute preferred modes for its practice. However, those of skill in the art should, in light of the present disclosure, appreciate that many changes can be made in the specific embodiments which are disclosed and still obtain a like or similar result without departing from the spirit and scope of the invention.

Further modifications and alternative embodiments of various aspects of the invention will be apparent to those skilled in the art in view of this description. Accordingly, this description is to be construed as illustrative only and is for the purpose of teaching those skilled in the art the general manner of carrying out the invention. It is to be understood that the forms of the invention shown and described herein are to be taken as examples of embodiments. Elements and materials may be substituted for those illustrated and described herein, parts and processes may be reversed, and certain features of the invention may be utilized independently, all as would be apparent to one skilled in the art after having the benefit of this description of the invention. Changes may be made in the elements described herein without departing from the spirit and scope of the invention as described in the following claims.

1. A wheelset monitoring device coupled to a bearing adapter, the wheelset monitoring device comprising:
a body having a shape and size configured to allow the body to be mounted against a portion of the bearing adapter;
one or more vibration sensors positioned with the body;
a processor coupled to. the one or more vibration sensors; and
a transmitter coupled to the processor;
wherein, during use, vibration information, monitored by the vibration sensors is collected by the processor, and wherein, during use, at least some of the vibration information is transmitted by the transmitter to a remote receiving device.

2. The wheelset monitoring device of claim 1, wherein the body comprises one or more openings extending through a portion of the body, wherein, during rise, fasteners are passed through the openings to connect the body to the portion of the bearing adapter.

3. The wheelset monitoring device of claim 1, wherein the shape and size of the body is such that, when an entirety of the body is in contact with the bearing adapter, a portion of the body is disposed over the center of the bearing adapter.

4. The wheelset monitoring device of claim 3, wherein at least one vibration sensor is positioned in the portion of the body disposed over the center of the bearing adapter.

5. The wheelset monitoring device of claim 1, wherein the body comprises a first compartment and a second compartment, the first compartment comprising one or more of the vibration sensors, and wherein the second compartment comprises the processor, the transmitter and a power source.

6. The wheelset monitoring device of claim 5, wherein the first compartment and second compartment are angled with respect to each other.

7. The wheelset monitoring device of claim 6, wherein the angle of the first compartment with respect to the second compartment is greater than 90 degrees.

8. (canceled)

9. The wheelset monitoring device of claim 1, further comprising one or more openings formed n the body at or near a location of one or more temperature sensors positioned in the body.

10. The wheelset monitoring device of claim 9, wherein the one or more openings are formed in a contact surface of the body.

11. The wheelset monitoring device of claim 1, further comprising a marking on the body indicating a location of a vibration sensor that is intended to be positioned over a center of the bearing adapter.

12. A bearing adapter of a railcar comprising;
a body having a substantially planar top surface, an arced bottom surface, and sidewalls connecting the top surface to the bottom surface, wherein the top surface receives a portion of a railcar side frame during use, and wherein the arced bottom surface rests on a portion of a bearing assembly during use;
one or more vibration sensors coupled to the body;
a control unit coupled to the body and the one or more vibration sensors, wherein the control unit comprises a processor, a transmitter coupled to the processor, and a power source coupled to the processor and the transmitter;
wherein, during use, vibration information, monitored by the vibration sensors is collected by the control unit, and wherein, during use, at least some of the vibration information is transmitted by the transmitter to a gateway device.

13. The bearing adapter of claim 12, wherein at least one vibration sensor is positioned above a center of the bearing assembly during use.

14. The bearing adapter of claim 12, further comprising one or more temperature sensors coupled to the body.

15. A method installing a wheelset monitoring device on a bearing adapter comprising:
obtaining a wheelset monitoring device, the wheelset monitoring device comprising:
a body having a shape and size configured to allow the body to be mourned against a portion of the bearing adapter; and
one or more vibration sensors disposed within the body; and
attaching the body against a sidewall of the bearing adapter, wherein, when attaching the body to the bearing adapter, the body is positioned such that at least one vibration sensor disposed within the body is oriented over a center of the bearing adapter.

16. The method of claim 15, wherein the body comprises one or more openings extending through a portion of the body, and wherein the method further comprises connecting the body to the bearing adapter using one or more fasteners that are passed through the openings.

17. The method of claim 15, wherein the body comprises a first compartment and a second compartment, the first compartment comprising one or more of the vibration sensors, and wherein the second compartment comprises a processor, a transmitter and a power source.

18. The method. of claim 17, wherein the first compartment and second compartment are angled with respect to each other.

19. The method of claim 18, wherein the angle of the first compartment with respect to the second compartment is greater than 90 degrees.

20. (canceled)

21. The method of claim 15, wherein the wheelset monitoring device further comprises one or more openings formed in the body at or near a location of one or more temperature sensors positioned in the body, and wherein when attaching the body against a sidewall of the bearing adapter, the one or more openings are oriented toward the sidewall of the bearing adapter.

22. The method of claim 15, wherein the wheelset monitoring device further comprises a marking on the body indicating a location of a vibration sensor that is intended to be positioned over a center of the bearing adapter, and wherein when attaching the body against a sidewall of the bearing adapter, the marking is positioned at the center of the bearing adapter.

23-57. (canceled)
